(19) United States
(12) Patent Application Publication
(10) Pub. No.: US 2022/0401838 A1
(43) Pub. Date: Dec. 22, 2022

(54) SYSTEM AND METHOD FOR EXTRACTING PHYSICAL AND MOTION DATA FROM VIRTUAL ENVIRONMENTS

(71) Applicant: The Meta Game, Inc., San Francisco, CA (US)

(72) Inventors: Thomas Nonn, Kenmore, WA (US); Jay Brown, Sunnyvale, CA (US); Garrett Krutilla, Pittsburgh, PA (US); Duncan Haberly, San Francisco, CA (US)

(73) Assignee: The Meta Game, Inc., San Francisco, CA (US)

(21) Appl. No.: 17/842,568

(22) Filed: Jun. 16, 2022

Related U.S. Application Data
(60) Provisional application No. 63/211,249, filed on Jun. 16, 2021.

(51) Int. Cl. A63F 13/52; G06V 20/40; G06T 7/13; G06T 5/00; G06T 5/20; G06V 10/44; G06T 7/246; G06T 7/11

(52) U.S. Cl. CPC A63F 13/52; G06V 20/41; G06T 7/13; G06T 5/003; G06T 5/20; G06V 10/443; G06T 7/248; G06V 20/49; G06T 7/11; G06T 2207/10016; G06T 2207/20192; G06T 2207/30241

(57) ABSTRACT

Embodiments described herein provide a system for analyzing a gameplay of a first video game. During operation, the system can obtain a stream of video frames associated with the gameplay. The system can then analyze the video frames to identify a set of features of the first video game. Here, a respective feature indicates the characteristics of a virtual object in a virtual environment of the first video game supported by a first game engine. Subsequently, the system can derive, based on the set of identified features, a set of parameters indicating one or more physical characteristics of one or more virtual objects in the virtual environment. The system can store the set of derived parameters in a file format readable by a second game engine different from the first game engine. This allows the second game engine to support a second video game that incorporates the physical characteristics.

### RELATED APPLICATION

This application claims the benefit of U.S. Provisional Application No. 63/211,249, Attorney Docket Number META21-1001PSP, titled “Method and System for Extracting Physical and Motion Characteristics of Virtual Objects within Virtual Environments,” by inventors Thomas Nonn, Jay Brown, Garrett Krutilla, and Duncan Haberly, filed 16 Jun. 2021, the disclosure of which is incorporated by reference herein.

### BACKGROUND

### Field

This disclosure is generally related to the field of computer vision. More specifically, this disclosure is related to a system and method for extracting the physical and motion characteristics of virtual objects in a virtual environment.

### Related Art

Gameplay in a video game is typically associated with a gamer traversing a virtual environment of the video game. For example, if the game is a shooting game, such as a first-person shooter game, the corresponding gameplay instance can include shooting at objects or characters in the virtual environment. Similarly, if the game is an exploration-based game, the gameplay instance can include accomplishing tasks during the exploration while avoiding damage to the gamer's character (e.g., an avatar in the virtual environment). The objective of the traversal in the gameplay instance may include accumulating points and/or reaching new (and challenging) levels. The video game may facilitate a recording of the gameplay instance in the virtual environment of the game.

The video game can be a first- and third-person video game. Each such video game can present a different virtual environment. As a result, traversing through that virtual environment can lead to a challenging gameplay corresponding to that video game. To advance in the video game, a player may need to use extended periods of play to improve the skill sets and adjust to the idiosyncrasies of the video game. Due to the individual nature of the virtual environment of a video game, the gaming skills associated with one video game may not be applicable to another.

### SUMMARY

Embodiments described herein provide a system for analyzing a gameplay instance of a first video game. During operation, the system can obtain a stream of video frames associated with the gameplay instance. The system can then analyze the video frames to identify a set of features of the first video game. Here, a respective feature can indicate the characteristics of a virtual object in a virtual environment of the first video game supported by a first game engine. Subsequently, the system can derive, based on the set of identified features, a set of parameters indicating one or more physical characteristics of one or more virtual objects in the virtual environment. The system can store the set of derived parameters in a file format readable by a second game engine different from the first game engine. This allows the second game engine to support a second video game that incorporates the one or more physical characteristics.

In a variation on this embodiment, the system can detect edges in a respective frame of the video frames by applying one or more thresholds. The system can then apply one or more filters to the frame to enhance the detected edges.

In a further variation, the system can detect the contours of one or more objects of the frame based on the enhanced detected edges. Here, a respective object is a virtual object in the virtual environment.

In a variation on this embodiment, the system can analyze the video by applying, to the video frames, one or more of: optical flow analysis and block movement analysis.

In a variation on this embodiment, the system can segment a scene in a respective frame of the video frames into one or more regions based on a computer-vision-based technique.

In a further variation, a segment of the scene can correspond to one of: a static element that does not change between the frame and a set of other frames, a target of an objective of the gameplay instance, and a semi-static element with limited movement between the frame and the set of other frames.

In a variation on this embodiment, the system can analyze the video by determining a weapon property associated with a weapon used in the gameplay instance. Here, the weapon property can include one or more of: a projectile trajectory property, a distribution property, a recoil property, a position of a strike, and a radius of a projectile.

In a variation on this embodiment, the system can derive the set of parameters by analyzing a scene of the gameplay instance from a plurality of camera views. Here, a respective camera view presents a different perspective of the scene.

In a variation on this embodiment, the system can analyze the video by determining the movement of an actor in the virtual environment. The actor can be controlled by a player of the gameplay instance. Here, the movement can include one or more of: strafing, looking up, looking down, running, crouching, and jumping.

In a variation on this embodiment, the system can analyze the video by determining player metrics associated with the gameplay instance based on the set of features and predetermined parameters of the first video game.

### BRIEF DESCRIPTION OF THE FIGURES

FIG. 1 illustrates an exemplary system that facilitates analysis of an input video of a gameplay instance in a virtual environment of a video game, in accordance with an embodiment of the present application.

FIG. 2A illustrates an exemplary segmentation of scene regions in a virtual environment of a video game, in accordance with an embodiment of the present application.

FIG. 2B illustrates an exemplary segmentation of scene regions using an artificial intelligence (AI) model in a virtual environment of a video game, in accordance with an embodiment of the present application.

FIG. 3A illustrates an exemplary use of optical flows for determining the scene motion in a virtual environment of a video game, in accordance with an embodiment of the present application.

FIG. 3B illustrates an exemplary use of computer vision filtering for determining trajectories and impacts of projectiles in a virtual environment of a video game, in accordance with an embodiment of the present application.

FIG. 4A illustrates exemplary projectile types in a virtual environment of a video game, in accordance with an embodiment of the present application.

FIG. 4B illustrates an exemplary change of scenes in a virtual environment of a video game, in accordance with an embodiment of the present application.

FIG. 5 illustrates an exemplary view of a third-person camera position overlapping with a game camera view in a virtual environment of a video game, in accordance with an embodiment of the present application.

FIG. 6 illustrates an exemplary side view of the third-person camera position in FIG. 5, in accordance with an embodiment of the present application.

FIG. 7 illustrates an exemplary top view of the third-person camera position in FIG. 5, in accordance with an embodiment of the present application.

FIG. 8 presents a flowchart illustrating a method of analyzing an input video of a gameplay instance in a virtual environment of a video game, in accordance with an embodiment of the present application.

FIG. 9 presents a flowchart illustrating a method of determining the distribution of projectiles in a gameplay instance in a virtual environment of a video game, in accordance with an embodiment of the present application.

FIG. 10 illustrates an exemplary computer system that facilitates analysis of an input video of a gameplay instance in a virtual environment of a video game, in accordance with an embodiment of the present application.

FIG. 11 illustrates an exemplary apparatus that facilitates analysis of an input video of a gameplay instance in a virtual environment of a video game, in accordance with an embodiment of the present application.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

### Overview

The embodiments described herein solve the problem of efficiently determining the characteristics of virtual objects in a virtual environment of a video game by (i) analyzing a respective frame of an input video of a gameplay instance of the video game; and (ii) extracting physical and motion characteristics of virtual objects of the virtual environment based on the analysis. The input video can be a pre-recorded video of the gameplay instance or a live video stream during the gameplay.

Computer games typically can include a virtual environment, actors operating in the environment, and virtual objects (e.g., tools) that can be used in the environment. The environment may also include other elements, such as images and special effects (e.g., projections of scores, a current level, etc.). The virtual environment of the game can be a three-dimensional virtual space where the gameplay occurs. The actors can be animated gaming characters (e.g., avatars) that the players can control to interact with the environment. Furthermore, the virtual objects can be tools, such as devices and actuators, that the gaming character can employ to perform a task or change the environment. The virtual objects are often modeled based on the type of the game.

For example, if the virtual objects are weapons, they can be used to destroy adversaries in the environment. If the game is a first-person shooter game, the weapons can be modeled after real-life examples. Such weapons may present realistic effects, such as recoil, scatter, and fragmentation, in the environment. On the other hand, in fantasy-based games, the weapons can be imaginative in design and function. During the gameplay, a player (or gamer) can control the actor to wield the virtual objects for traversing the environment to achieve an objective. The player may need extended periods of play with the virtual objects to improve the skill and adjust to the idiosyncrasies of the environment.

With existing technologies, a respective game may have a virtual environment that represents the specific nature of the game, such as the video game engine and the graphics playback system of the game. Even within the same game, different levels can be associated with different virtual environments. The respective behaviors of a virtual object, such as a weapon, can be different in different environments. As a result, representing the characteristics of a virtual object in different environments may require extensive design and development for individual environments.

To solve this problem, embodiments described herein provide an environment analysis system that can extract physical and motion characteristics from the virtual objects from a video file of a gameplay instance of a video game. The video file can capture how actors, virtual objects, and special effects interact in the virtual environment of the video game. During the gameplay, a player can perform certain tasks with the virtual objects in the virtual environment. The execution of the tasks can be recorded in a variety of scenes in the video file. The system can observe and analyze the gameplay and corresponding special effects recorded in the video to determine the specific physical and motion characteristics of the virtual objects.

The system can use computer-vision algorithms on the video frames of the video file to perform the analysis. The system can compute the three-dimensional, physical properties of the virtual objects from the graphics in their two-dimensional, projected representations in the video frames. The computed properties can then be used for recreating the physical and motion characteristics in other virtual environments associated with other video game engines or graphics playback systems, which can be different from the one on which the gameplay has been recorded.

### Exemplary Analysis System

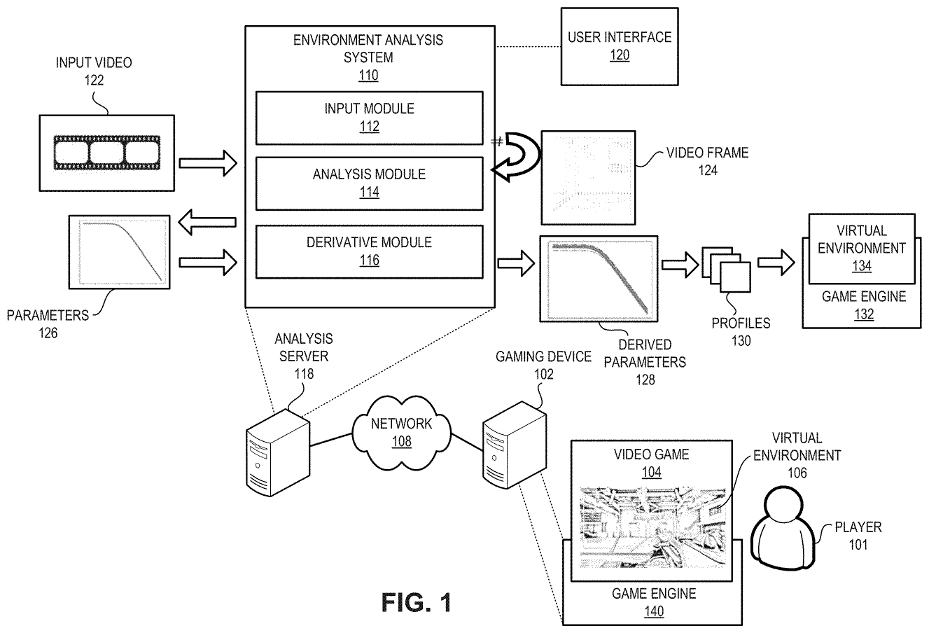

FIG. 1 illustrates an exemplary system that facilitates analysis of an input video of a gameplay instance in a virtual environment of a video game, in accordance with an embodiment of the present application. A video game 104 may be developed based on a game engine 140. Video game 104 can run on a gaming device 102. Examples of gaming device 102 can include, but are not limited to, a computing device (e.g., a laptop or desktop), a gaming console, a cellular device, and a tablet. Computer game 104 can include a virtual environment 106 that may include a three-dimensional virtual space where a player 101 may play video game 104. In other words, environment 106 is a virtual space where the gameplay of player 101 occurs.

Game 104 can also include actors operating in environment 106 and virtual objects that can be used in environment 106. Environment 106 may also include other elements, such as images and special effects (e.g., projections of scores, a current level, etc.). The actors can be animated gaming characters (e.g., avatars) that player 101 can control to interact with environment 106. Furthermore, the virtual objects in environment 106 can be tools, such as devices and actuators, that the gaming character can employ to perform a task or change environment 106. The virtual objects are often modeled based on the type of the game.

For example, if game 104 is a first-person shooter game, the virtual objects can be weapons for destroying adversaries in environment 106. These weapons can be modeled after real-life examples. Such weapons may present realistic effects, such as recoil, scatter, and fragmentation, in environment 106. On the other hand, in fantasy-based games, the weapons can be imaginative in design and function. During the gameplay, player 101 can control the actor to wield the virtual objects for traversing environment 106 to achieve an objective. Player 101 may need extended periods of play with the virtual objects to improve the skill and adjust to the idiosyncrasies of environment 106.

With existing technologies, environment 106 may represent the specific nature of game 104, such as the video game engine and the graphics playback system of game 104. Even within the same game 104, different levels can be associated with different virtual environments. The respective behaviors of a virtual object, such as a weapon, can be different in different environments. As a result, representing the characteristics of a virtual object in different environments may require extensive design and development for individual environments.

To solve this problem, an environment analysis system 110 can extract physical and motion characteristics from the virtual objects from an input video 122 of a gameplay instance of game 104. System 110 can operate on an analysis server 118, which can be reachable via a network 108, which can be a local or a wide area network. Analysis server 118 can be a physical or virtual machine and may be collocated with gaming device 102. Input video 122 can be recorded on gaming device 102. System 110 may obtain input video 122 via network 108.

System 110 can also provide analysis tools via a user interface 120. Since system 110 operates on analysis server 118, user interface 120 may appear as an interface on analysis server 118. User interface 120 can include one or more of: a textual interface, a graphical interface, a touch interface, and a gesture interface. User interface 120 can allow a user performing the analysis on input video 122 to specify the analysis operations to be performed and specify their corresponding input parameters.

Input video 122 can be a recording or a video stream of the gameplay instance. Input video 122 can capture how actors, virtual objects, and special effects interact in environment 106. During the gameplay, player 101 can perform certain tasks with the virtual objects in environment 106. The execution of the tasks can be recorded in a variety of scenes in input video 122. An input module 112 of system 110 can obtain a video frame 124 from input video 122. An analysis module 114 of system 110 can then observe and analyze the gameplay and corresponding special effects recorded in video frame 124 to determine the specific physical and motion characteristics of the virtual objects captured in video frame 124.

Analysis module 114 can use computer-vision algorithms on video frame 124 to perform the analysis. System 110 can compute parameters 126 representing the three-dimensional, physical characteristics of the virtual objects from the graphics in the two-dimensional, projected representations in video frame 124. A derivative module 116 of system 110 can use parameters 126 to derive (or recreate) parameters 128 representing the physical and motion characteristics in other virtual environments associated with other video game engines or graphics playback systems, which can be different from game engine 140 (i.e., the one on which the gameplay has been recorded).

Here, system 110 can observe, deduce, analyze, and synthesize the physical and motion parameters of objects within a variety of first- and third-person video games. Such characteristics can later be used in the recreation of those parameters applied to other objects within other virtual environments. System 110 can use computer vision algorithms to observe frames of input video 122, which can be arranged in a specific manner to indicate the variety of tasks performed by player 101. System 110 can analyze a respective task performed by player 101. The analysis involves computing a collection of parameters 126 representing the physical and motion characteristics of the virtual objects in environment 106.

Derivative module 116 can perform the derivative analysis on parameters 126 to transform them into derived parameters 128 that can be used to recreate the physical and motion characteristics of the analyzed objects in a different target game engine or in a different instance of the original game engine. Derivative module 116 may calculate the derivatives for a respective virtual object for which analysis module 114 has determined the physical characteristics. For example, when analysis module 114 determines the number of frames it takes for an action to take place in environment 106, derivative module 116 may derive the corresponding time in seconds (e.g., based on frames per second).

System 110 can then aggregate related game-engine inputs into exportable profiles 130 that can be imported into a receiving game engine 132. Subsequently, game engine 132 can process the data in exported profiles 130 to efficiently recreate the physical and motion characteristics of new virtual objects in virtual environment 134 operating on game engine 132. In this way, system 110 can synthesize parameters 126 to allow derivative module 116 to recreate the similar physical and motion characteristics in another game engine.

### Extraction of Characteristics

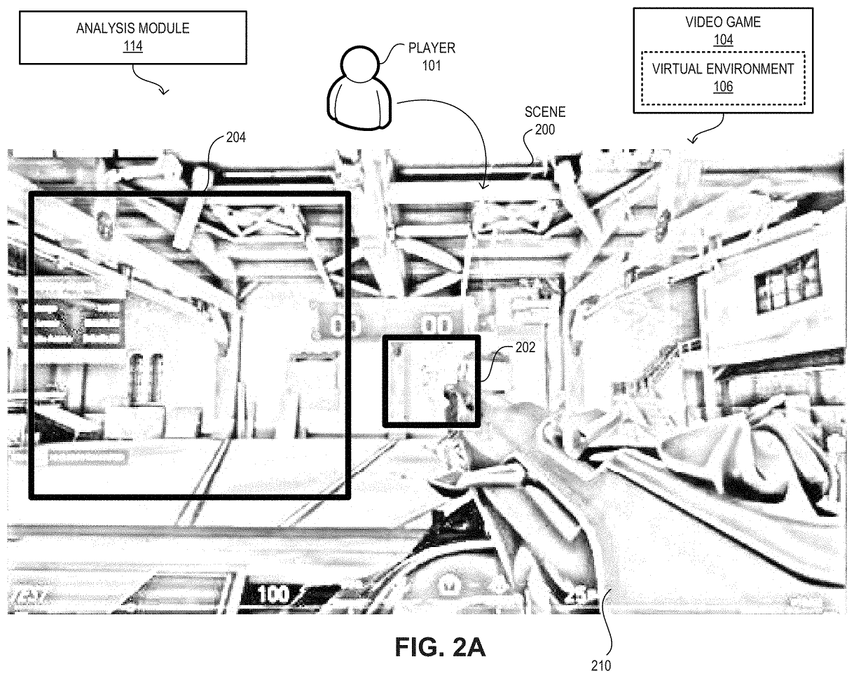

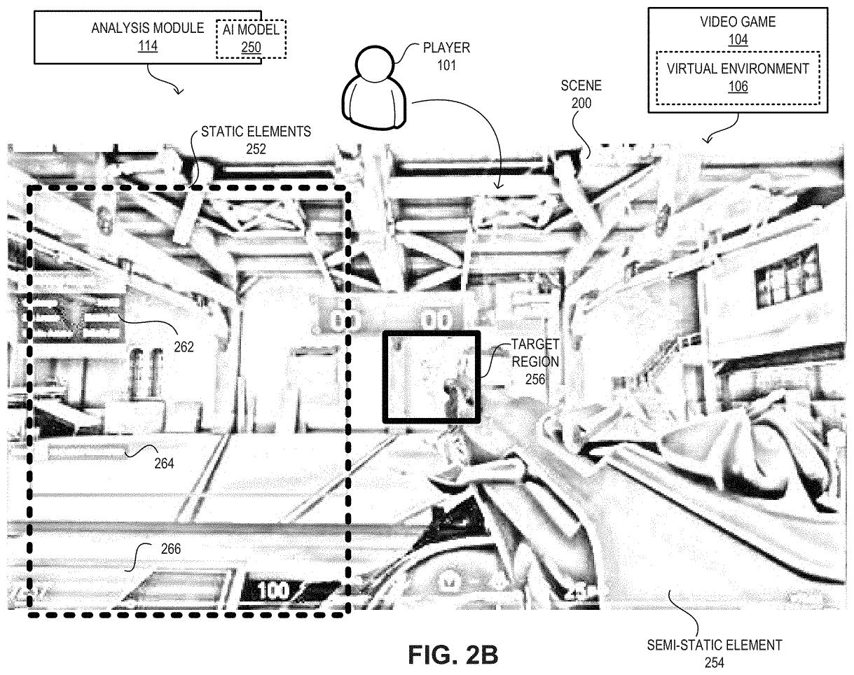

To facilitate the analysis of a first-person shooter game, analysis module 114 can analyze a number of features of the gameplay, such as actor movement, weapons analysis, scene changes, player metrics, and camera placement. FIG. 2A illustrates an exemplary segmentation of scene regions for determining scene movement in a virtual environment of a video game, in accordance with an embodiment of the present application. Analysis module 114 can determine the rate of movement of an actor 210 controlled by player 101 in environment 106 based on a number of actions performed by actor 210. Examples of the actions of actor 210 can include, but are not limited to, strafing, looking up or down, running, crouching, and jumping.

Analysis module 114 can evaluate the motion of actor 210 can by determining the speed and/or acceleration of actor 210. In some embodiments, analysis module 114 can identify important elements of a scene 200 (e.g., the scene in a video frame), such as the position of the floor junction. Furthermore, analysis module 114 can use the content of scene 200 to select a region of interest (RoI) 202 in scene 200. If scene 200 is from a first-person shooter game, actor 210 might be partially cloaked. Analysis module 114 can then apply scene segmentation to scene 200 to discern moving and non-moving regions. In this example, RoI 202 can correspond to the moving region. On the other hand, non-moving region 204 in scene 200 can correspond to static elements, such as the projection of score, within environment 106.

FIG. 2B illustrates an exemplary segmentation of scene regions using an AI model for determining scene movement in a virtual environment of a video game, in accordance with an embodiment of the present application. Analysis module 114 can perform the segmentation using an AI model 250, such as a machine-learning-based algorithm. By applying AI model 250 on scene 200, analysis module 114 can determine scene movements, which can include one or more of: horizontal movements when actor 210 is travelling (e.g., running or walking), the distance covered when actor 210 jumps, the distance covered when actor 210 crouches, and rotation of scene 200 when the view is pointing at zenith.

To determine the movement of scene 200 or the elements in scene 200, analysis module 114 can divide scene 200 into regions or RoIs. AI model 250 can determine static elements (e.g., information displays), semi-static or small movement elements (e.g., weapons), and regions of large movements (e.g., background, target, distance) from a scene. The partitioning of these elements depends on game 104 and the weapons used by actor 210. For example, AI model 250 can determine static elements 252, such as a game parameter projection 262, instruction projection 264, and aesthetic elements 266. AI model 250 can also identify the weapon of actor 210 as a semi-static element 254. Furthermore, AI model 250 can determine a target region 256 corresponding to the target of the weapon of actor 210. In other words, target region 256 can represent the objective of actor 210 during the gameplay.

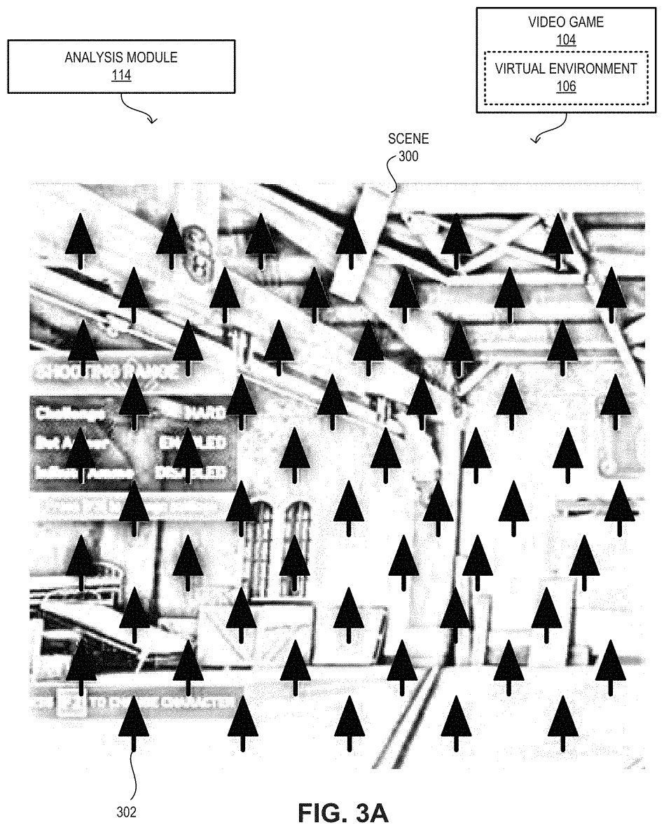

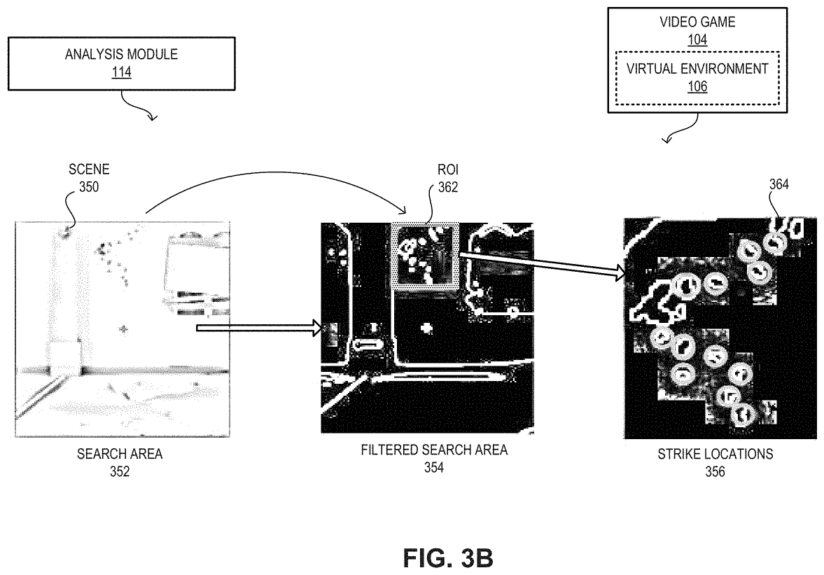

FIG. 3A illustrates an exemplary use of optical flows for determining the scene motion in a virtual environment of a video game, in accordance with an embodiment of the present application. In this example, analysis module 114 can determine the motion for a scene 300 of a gameplay instance of environment 106 based on the optical flow and block movement. Scene 300 may appear on a video frame of an input video. For example, analysis module 114 can analyze the scenes prior to scene 300 (i.e., the video frames prior to the current video frame) and determine the “velocity of points,” such as velocity 302, to estimate the movement of the object.

In other words, analysis module 114 can estimate the motion associated with scene 300 based on the pixel movement between scene 300 and one or more prior scenes. The estimated result can be at the pixel level, which can be interpolative. Analysis module 114 may use or more techniques to determine the optical flow. Examples of such techniques include, but are not limited to, Lukas-Kanade (based on 3×3 patch where all points have the same motion), Farneback (based on polynomial expansion), robust local optical flow (RLOF), and dual total variation (TV) L¹ (provides realtime optical flow).

Another feature analyzed by analysis module 114 can include weapons dispersion. In particular, the firing of weapons can result in a distribution of hits at some distance from an actor in environment 106. FIG. 3B illustrates an exemplary use of computer vision filtering for determining trajectories and impacts of projectiles in a virtual environment of a video game, in accordance with an embodiment of the present application. In this example, a scene 350 of a gameplay instance of environment 106 can include shooting at a wall. The pattern of the shooting (i.e., the movement of the projectiles) can be modeled using computer vision algorithms.

Analysis module 114 can apply computer vision filtering and tracking methods on scene 350. In other words, scene 350 can correspond to the search area 352 for the computer vision filtering and tracking. By applying thresholds and computer vision filtering, analysis module 114 can generate filtered search area 354, and identify and characterize projectile trajectories and distributions of hits on strike locations 356 from the projectiles. For example, analysis module 114 can apply computer vision filtering to determine RoI 362 on filtered search area 354 corresponding to strike locations 356. Analysis module 114 can then identify individual strike location, such as location 364, on filtered search area 354 within RoI 362. In this way, analysis module 114 can determine strike location 356 of the projectiles using computer vision filtering.

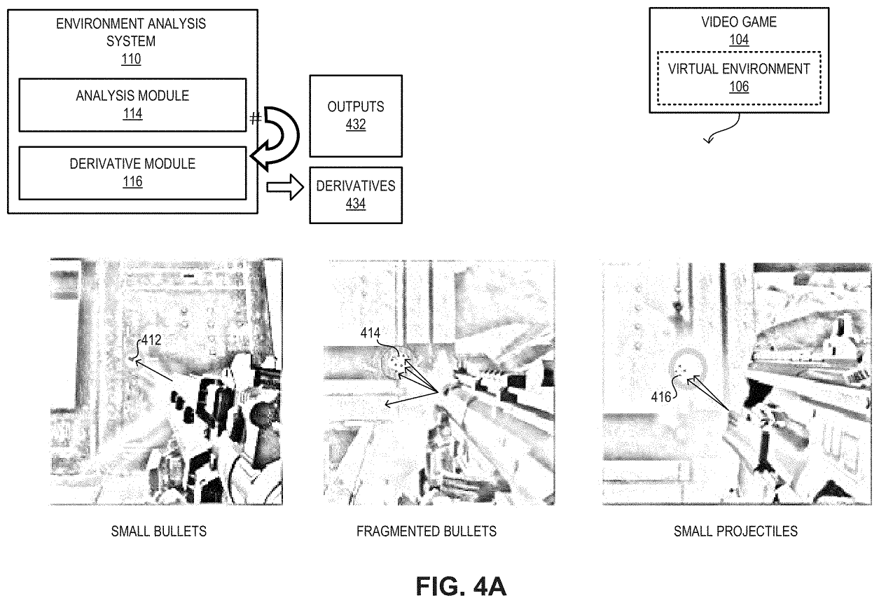

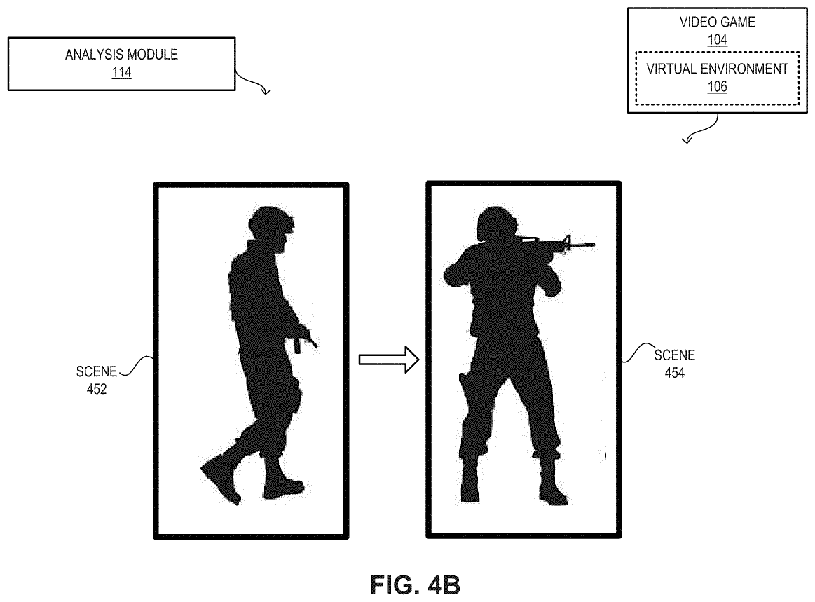

FIG. 4A illustrates exemplary projectile types in a virtual environment of a video game, in accordance with an embodiment of the present application. Typically, projectiles can vary considerably from game to game. Some projectiles may emulate real-life counterparts, while others may be fantasy-based and create non-real-life distributions of hits. Accordingly, analysis module 114 can determine the parameters of interest, such as the strike locations (relative to crosshair position), the radius of the projectile, the amount of recoil, and the eye distance to the floor. The speed of the projectile or repeat rate between firings can also be of interest.

Analysis module 114 can use computer vision techniques to determine additional weapon characteristics, such as muzzle blast diameter and energy spread after detonation. For example, analysis module 114 can determine the impact of small bullets 412, fragmented bullets 414, and small projectiles 416 under different scenarios. This allows analysis module 114 to determine the parameters of interest for different weapons used by the actors. By determining the spatial distribution and firing rate of projectiles emitted from weapons, analysis module 114 can determine the player's accuracy and effectiveness in environment 106.

Analysis module 114 can determine when an actor, while being controlled by the player, in environment 106 has initiated the launching of the projectile. For example, if the projectiles include bullets fired from a weapon, analysis module 114 can determine the time when the actor has pulled the trigger. Analysis module 114 can analyze different stages of firing of the weapon to determine the time. These stages can include muzzle flash, projectile trace, projectile strike, and impact flash.

Muzzle flash, which may not be present in some virtual environments, can indicate the brief flash near the muzzle of the weapon. Upon leaving the muzzle, the projectile can leave a path or trace until reaching the target. This path can be referred to as the projectile trace and may be visible in environment 106. Subsequently, when the projectile strikes the target (e.g., a wall), the projectile can leave a brief sprite (i.e., a short-lived flash) indicating the contact. After the strike, there can be an increasing ring of diminishing energy, usually visible for large grenades or explosive projectiles, in environment 106.

Depending on the weapon, analysis module 114 can analyze each stage of the projectile discharge using computer-vision techniques. In particular, analysis module 114 can determine the position of the projectile strike on the target, as described in conjunction with FIG. 3B. For testing, a wall perpendicular to the firing direction can be used to evaluate the spread of projectiles in environment 106. When a projectile is fired, the firing weapon can recoil (e.g., a vertical movement of the weapon) due to the discharge forces. As more projectiles are fired, the recoil is compounded and can force the weapon to a higher attitude. Game 104 may apply a statistical spread when projectiles are fired, which can vary based on the weapon. As a result, the firing of a large number of projectiles may leave a pattern on the target.

Analysis module 114 can determine the respective positions of the strikes based on the projectile type. For projectiles, such as bullet 412, that leave bright round strikes on the target, the diameters of the strike locations may not vary significantly. Hence, analysis module 114 can use histogram methods to evaluate the strike locations. On the other hand, for more fragmentary projectiles, such as fragmented bullets 414 or small projectiles 416, analysis module 414 can use a blob detection approach to evaluate the strike locations.

Prior to the evaluation, analysis module 114 can apply filtering on the scene to remove unnecessary edge information from the detection process, as described in conjunction with FIG. 3B. Analysis module 114 can generate a set of outputs 432 from the weapons analysis. Outputs 432 can include one or more of: coordinates, the amount of recoil, temporal information, and the spacing between firings. The coordinates can be the Cartesian coordinates in image space with respect to the crosshair projected in environment 106. Furthermore, the amount of recoil can correspond to the vertical and/or horizontal recoils of weapons. Temporal information can include timestamps and frame numbers.

When outputs 432 is generated, derivative module 116 can use the projectile information to calculate derivatives 434 that can be exported to other game engines. Derivatives 434 can include physical parameters that can be applicable to the virtual objects in the respective virtual environments of the other game engines. Derivatives 434 can include one or more of: spread angles, a firing rate, a distance from projectile strike to the floor, and a distance to a target. The spread angles can be measured in degrees and include the minimum and maximum spread angles of the weapon. Derivative module 116 can use the field-of-view of the scene and the framerate of the game to the determine the spread angles.

FIG. 4B illustrates an exemplary change of scenes in a virtual environment of a video game, in accordance with an embodiment of the present application. In environment 106, a change in how an actor holds a virtual object can cause a change of scenes. For example, an actor may hold a weapon in a relaxed position in scene 452. If the actor changes position to hold the weapon in a ready-to-use position, scene 452 can transition to a different scene 454. Similarly, switching from an iron sight to sniper scope can cause another such transition. These transitions are often repeated in environment 106. Nonetheless, such transition can also vary among different games and/or weapons. Analysis module 114 can determine the rate of change for these transitions.

TABLE 1
Exemplary internal parameters for a game.

| Internal parameters | Description |
|---|---|
| Focal length | The distance to the image plane |
| | in perspective projection |
| Field-of-view | Measures (e.g., in degrees) how much |
| | of a scene is captured in an image |
| Gravity | The acceleration that actors |
| | exhibit when falling |
| Frame rate | The rate that frames are generated |
| | through the render process or played back |

Analysis module 114 can also determine player metrics, which are features determined based on the measurement of other parameters, such as player movement, weapon dispersion, and scene changes, together with internal parameters of game 104 (e.g., as applied to environment 106). The internal parameters can include, but are not limited to, field-of-view, focal length, gravity, frame rate, and screen resolution. Table 1 lists a set of exemplary internal parameters for game 104. The determined player metrics can include, but are not limited to, running speed, crouching speed, standing eye height, jump height, jump velocity, bullet spread, and firing rate. Table 2 lists a set of exemplary player metrics determined by analysis module 104 for game 104.

TABLE 2
Exemplary player metrics determined for a game.

| Player metrics | Description |
|---|---|
| Bullet spread | The angular spread of projectiles while the |
| | weapon is kept in one position |
| Bullet rate | The rate of fire while the trigger is kept |
| | in an active state |
| Bullet count | The number of bullets that can be fired |
| | between reloads |
| Firing delay | The delay in the time when the user presses |
| | a key and weapons begin to fire |
| Recoil | The vertical and/or horizontal motion of |
| | the weapon caused by firing |
| Running speed | The speed at which an actor moves |
| | while running |
| Crouching speed | The speed at which an actor moves |
| | while crouched |
| Standing eye height | The distance (e.g., in pixels) from an |
| | actor’s eyes to the ground |
| Jump height | The vertical height distance (e.g., in pixels) |
| | an actor jumps (observed as scene movement) |
| Jump velocity | The rate of motion when an actor jumps |
| Crouch distance | The amount of vertical distance (e.g., in |
| | pixels) an actor crouches |
| Frames to | The number of frames measured before |
| max charge | a weapon is fully charged |
| ADS zoom | The number of frames it takes to switch |
| | from normal view to scope view |

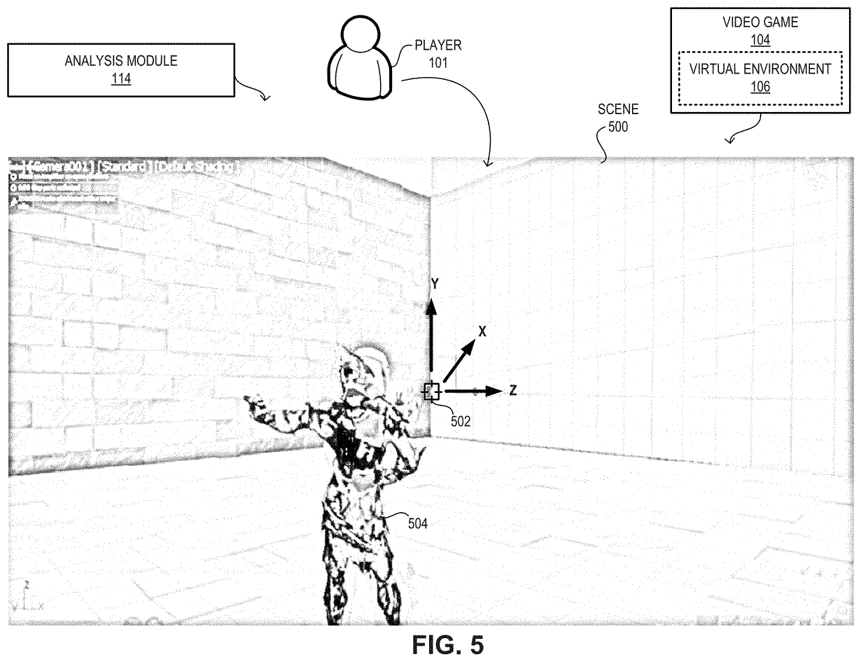

Analysis module 114 can determine the physical properties associated with the player metrics based on the scene and the distances in the corresponding scenes. FIG. 5 illustrates an exemplary view of a third-person camera position overlapping with a game camera view in a virtual environment of a video game, in accordance with an embodiment of the present application. Analysis module 114 may use a computer vision algorithm, such as Structure from Motion (SfM), to determine the camera position of a scene 500 of a gameplay instance of environment 106. Scene 500 may appear on a video frame of an input video.

Analysis module 114 may use the computer vision algorithm to determine that the target direction of the camera of scene 500 has overlaid a crosshair 502. Hence, the perspective of scene 500 can be the perspective of actor 504 (i.e., the actor controlled by player 101) in scene 500. Accordingly, analysis module 114 can determine that the view represented in scene 500 overlaps with the game camera (e.g., the primary camera view used by player 101 for the gameplay).

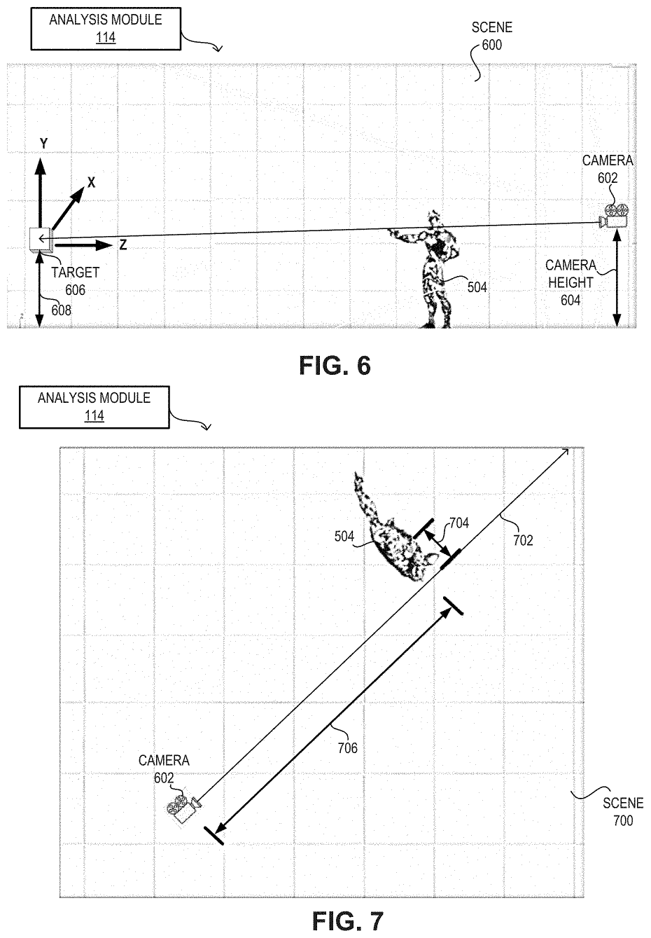

Game 104 may support multiple camera views. Hence, player 101's perspective can be moved or switched to a third-person view in environment 106. FIG. 6 illustrates an exemplary side view of the third-person camera position in FIG. 5, in accordance with an embodiment of the present application. Scene 600 can show the position of camera 602 that has provided the view in scene 500 of FIG. 5 from the side view. Analysis module 114 can then determine height 604 of camera 602 from scene 600 based on the computer vision algorithm. Analysis module 114 can also determine target 606 of camera 602 in scene 600. Analysis module 114 can then determine height 608 of target 606. Here, heights 604 and 608 can be the same or different.

FIG. 7 illustrates an exemplary top view of the third-person camera position in FIG. 5, in accordance with an embodiment of the present application. Scene 700 can show the position of camera 602 that has provided the view in scene 500 of FIG. 5 from the top view. Analysis module 114 can apply the computer vision algorithm on scene 700 to determine distance 706 between the position of camera 602 and actor 504. Analysis module 114 can also determine distance 704 between the line of direction 702 of camera 602 and actor 504 in scene 700. Analysis module 114 can supplement the information obtained from scene 500 with the information determined from scenes 600 and 700 to increase the accuracy of the physical parameters.

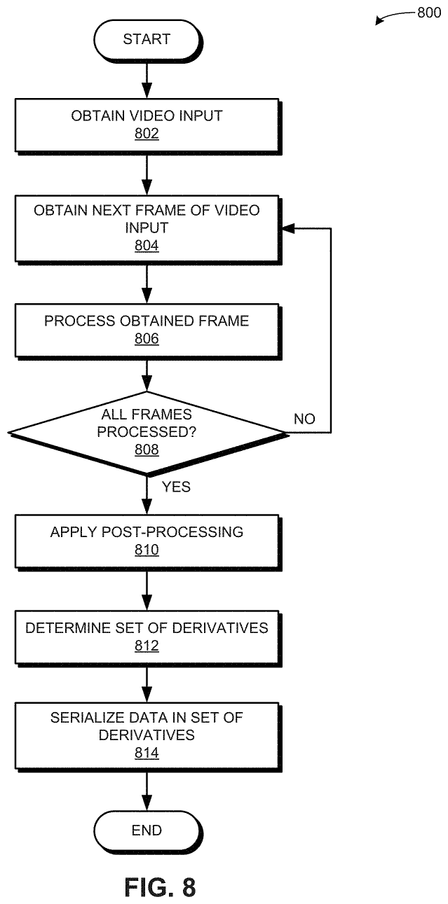

FIG. 8 presents a flowchart illustrating a method of analyzing an input video of a gameplay instance in a virtual environment of a video game, in accordance with an embodiment of the present application. During operation, an environment analysis system can obtain a video input (operation 802). The system can obtain the next frame of the video input (operation 804) and process the obtained frame (operation 806). Processing the frame can include analyzing the scene of the gameplay represented in the frame.

The system can then determine whether all frames are processed (operation 808). If all frames are not processed, the system can continue to obtain the next frame of the video input (operation 804). On the other hand, if all frames are processed, the system can apply post-processing (operation 810) and determine a set of derivatives (operation 812). The system can then serialize the data in the set of derivatives (operation 814).

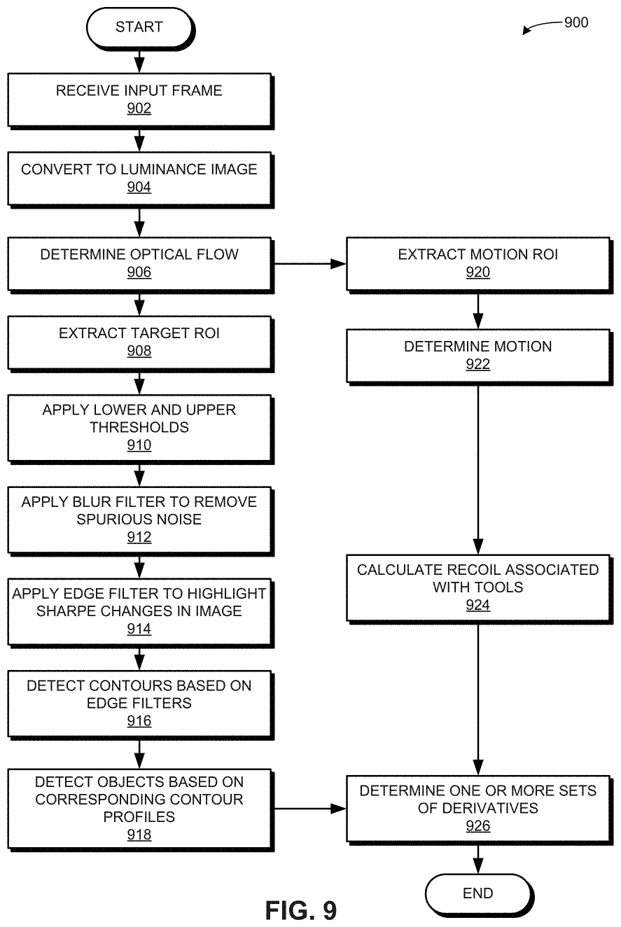

FIG. 9 presents a flowchart illustrating a method of determining the distribution of projectiles in a gameplay instance in a virtual environment of a video game, in accordance with an embodiment of the present application. During operation, an environment analysis system can receive an input frame (operation 902) and convert it to a luminance image (operation 904). For example, the three-component color (red, green, and blue, or RGB) image of the frame can be converted to a grayscale image.

The system can then determine the optical flow for the frame (operation 906). Based on the optical flow, the system can extract the motion RoI (operation 920). The system can segment the optical flow field of the entire scene according to motion. For example, the system can determine the static and semi-static regions from the scene. The system can then determine the motion using the output from the optical flow (operation 922). The system can determine the rate of motion for specific scene objects.

The system can also calculate the recoil associated with tools, such as weapons (operation 924). The system can also extract the target RoI from the optical flow (operation 908). The target RoI can be a region in the center of the scene where all projectiles are projected to. Hence, the target RoI can correspond to the objective of the gameplay. The system can then detect the projectiles in the target RoI. Subsequently, the system can apply upper and lower thresholds to remote extraneous data (operation 910). The system can also apply blur filter (e.g., low-frequency filter, such as Gaussian, box, and median) to remove spurious noise from the frame (operation 912).

Subsequently, the system can apply edge filter (e.g., high-frequency filter, such as Canny, Sobel, and Laplacian) to highlight sharp changes in the frame (operation 914). The system can then detect the contours in the frame based on the edge filters (operation 916). For example, the system can identify the closed contours by analyzing the four- or eight-point neighbors to determine connectivity. The system can detect objects based on the corresponding contour profiles (operation 918). The system can perform the object detection process based on one or more of: geometric considerations, match-moving methods, or machine-learning approaches.

Upon calculating the recoil (operation 924) or detecting the objects (operation 918), the system can determine one or more sets of derivatives (operation 926). Determining the derivatives can include high-level processing resulting in the conversion of pixel-based results to physically meaningful units. For example, the output of the optical flow can be the pixel deformation from one frame to the next. This result can be converted to motion information using the framerate (e.g., the time between frames). With the addition of field of view dimensions, the system can convert this information to physical units.

### Exemplary Computer System and Apparatus

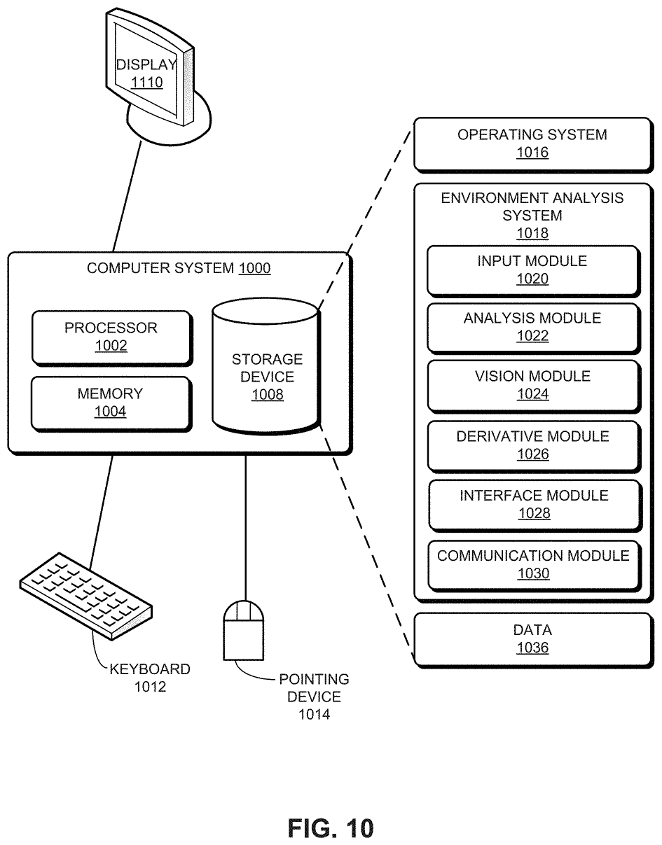

FIG. 10 illustrates an exemplary computer system that facilitates analysis of an input video of a gameplay instance in a virtual environment of a video game, in accordance with an embodiment of the present application. Computer system 1000 includes a processor 1002, a memory device 1004, and a storage device 1008. Memory device 1004 can include a volatile memory device (e.g., a dual in-line memory module (DIMM)). Furthermore, computer system 1000 can be coupled to a display device 1010, a keyboard 1012, and a pointing device 1014. Storage device 1008 can store an operating system 1016, a parameter generation system 1018, and data 1036. Environment analysis system 1018 can facilitate the operations of system 110.

Environment analysis system 1018 can include instructions, which when executed by computer system 1000 can cause computer system 1000 to perform methods and/or processes described in this disclosure. Specifically, environment analysis system 1018 can include instructions for obtaining an input video file of a gameplay in a virtual environment of a game and extracting a respective frame of the input video for analysis (input module 1020). Environment analysis system 1018 can also include instructions for analyzing the frame to obtain physical and motion characteristics of the virtual objects in the virtual environment (analysis module 1022).

Furthermore, environment analysis system 1018 includes instructions for using computer-vision algorithms to perform the analysis (vision module 1024). Environment analysis system 1018 can also include instructions for determining the derivatives that can be exported to other game engines (derivative module 1026). Moreover, environment analysis system 1018 can also include instructions for providing analysis tools via a user interface (interface module 1028).

Environment analysis system 1018 may further include instructions for sending and receiving messages (communication module 1030). Data 1036 can include any data that can facilitate the operations of system 110. Data 1036 may include one or more of: an input video, parameters indicating the characteristics of virtual objects, and derived parameters exportable to other devices.

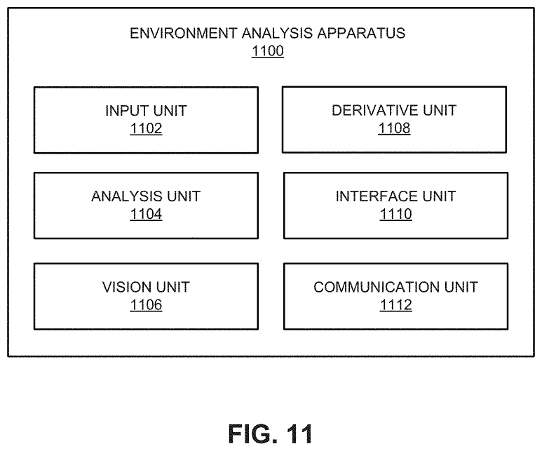

FIG. 11 illustrates an exemplary apparatus that facilitates analysis of an input video of a gameplay instance in a virtual environment of a video game, in accordance with an embodiment of the present application. Environment analysis apparatus 1100 can comprise a plurality of units or apparatuses which may communicate with one another via a wired, wireless, quantum light, or electrical communication channel. Apparatus 1100 may be realized using one or more integrated circuits, and may include fewer or more units or apparatuses than those shown in FIG. 11.

Further, apparatus 1100 may be integrated in a computer system, or realized as a separate device that is capable of communicating with other computer systems and/or devices. Specifically, apparatus 1100 can comprise units 1102-1112, which perform functions or operations similar to modules 1020-1030 of computer system 1000 of FIG. 10, including: an input unit 1102; an analysis unit 1104; a vision unit 1106; a derivative unit 1108; an interface unit 1110; and a communication unit 1112.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing embodiments described herein have been presented for purposes of illustration and description only. They are not intended to be exhaustive or to limit the embodiments described herein to the forms disclosed. Accordingly, many modifications and variations will be apparent to practitioners skilled in the art. Additionally, the above disclosure is not intended to limit the embodiments described herein. The scope of the embodiments described herein is defined by the appended claims.

What is claimed is:

1. A method for analyzing a gameplay instance of a first video game, the method comprising:
obtaining a stream of video frames associated with the gameplay instance;
analyzing the video frames to identify a set of features of the first video game, wherein a respective feature indicates characteristics of a virtual object in a virtual environment of the first video game supported by a first game engine;
deriving, based on the set of identified features, a set of parameters indicating one or more physical characteristics of one or more virtual objects in the virtual environment; and
storing the set of derived parameters in a file format readable by a second game engine different from the first game engine, thereby allowing the second game engine to support a second video game that incorporates the one or more physical characteristics.

2. The method of claim 1, further comprising:
detecting edges in a respective frame of the video frames by applying one or more thresholds; and
applying one or more filters to the frame to enhance the detected edges.

3. The method of claim 2, further comprising detecting contours of one or more objects of the frame based on the enhanced detected edges, wherein a respective object is a virtual object in the virtual environment.

4. The method of claim 1, wherein analyzing the video frames further comprises applying, to the video frames, one or more of: optical flow analysis and block movement analysis.

5. The method of claim 1, further comprising segmenting a scene in a respective frame of the video frames into one or more regions based on a computer-vision-based technique.

6. The method of claim 5, wherein a segment of the scene corresponds to one of:
a static element that does not change between the frame and a set of other frames;
a target of an objective of the gameplay instance; and
a semi-static element with limited movement between the frame and the set of other frames.

7. The method of claim 1, wherein analyzing the video frames further comprises determining a weapon property associated with a weapon used in the gameplay instance;
wherein the weapon property comprises one or more of: a projectile trajectory property, a distribution property, a recoil property, a position of a strike, and a radius of a projectile.

8. The method of claim 1, wherein deriving the set of parameters further comprises analyzing a scene of the gameplay instance from a plurality of camera views, wherein a respective camera view presents a different perspective of the scene.

9. The method of claim 1, wherein analyzing the video frames further comprises determining movement of an actor in the virtual environment, wherein the actor is controlled by a player of the gameplay instance;
wherein the movement comprises one or more of: strafing, looking up, looking down, running, crouching, and jumping.

10. The method of claim 1, wherein analyzing the video frames further comprises determining player metrics associated with the gameplay instance based on the set of features and predetermined parameters of the first video game.

11. A non-transitory computer-readable storage medium storing instructions that when executed by a computer cause the computer to perform a method for analyzing a gameplay instance of a first video game, the method comprising:
obtaining a stream of video frames associated with the gameplay instance;
analyzing the video frames to identify a set of features of the first video game, wherein a respective feature indicates characteristics of a virtual object in a virtual environment of the first video game supported by a first game engine;
deriving, based on the set of identified features, a set of parameters indicating one or more physical characteristics of one or more virtual objects in the virtual environment; and
storing the set of derived parameters in a file format readable by a second game engine different from the first game engine, thereby allowing the second game engine to support a second video game that incorporates the one or more physical characteristics.

12. The non-transitory computer-readable storage medium of claim 11, wherein the method further comprises:
detecting edges in a respective frame of the video frames by applying one or more thresholds; and
applying one or more filters to the frame to enhance the detected edges.

13. The non-transitory computer-readable storage medium of claim 12, wherein the method further comprises detecting contours of one or more objects of the frame based on the enhanced detected edges, wherein a respective object is a virtual object in the virtual environment.

14. The non-transitory computer-readable storage medium of claim 11, wherein analyzing the video frames further comprises applying, to the video frames, one or more of: optical flow analysis and block movement analysis.

15. The non-transitory computer-readable storage medium of claim 11, further comprising segmenting a scene in a respective frame of the video frames into one or more regions based on a computer-vision-based technique;
wherein a respective segment of the scene corresponds to one of:
a static element that does not change between the frame and a set of other frames;
a target of an objective of the gameplay instance; and
a semi-static element with limited movement between the frame and the set of other frames.

16. The non-transitory computer-readable storage medium of claim 11, wherein analyzing the video frames further comprises determining a weapon property associated with a weapon used in the gameplay instance;
wherein the weapon property comprises one or more of: a projectile trajectory property, a distribution property, a recoil property, a position of a strike, and a radius of a projectile.

17. The non-transitory computer-readable storage medium of claim 11, wherein deriving the set of parameters further comprises analyzing a scene of the gameplay instance from a plurality of camera views, wherein a respective camera view presents a different perspective of the scene.

18. The non-transitory computer-readable storage medium of claim 11, wherein analyzing the video frames further comprises determining movement of an actor in the virtual environment, wherein the actor is controlled by a player of the gameplay instance;
wherein the movement comprises one or more of: strafing, looking up, looking down, running, crouching, and jumping.

19. The non-transitory computer-readable storage medium of claim 11, wherein analyzing the video frames further comprises determining player metrics associated with the gameplay instance based on the set of features and predetermined parameters of the first video game.

20. A computer system, comprising:
a storage device;
a processor;
a non-transitory computer-readable storage medium storing instructions, which when executed by the processor causes the processor to perform a method for analyzing a gameplay instance of a first video game, the method comprising:
obtaining a stream of video frames associated with the gameplay instance;
analyzing the video frames to identify a set of features of the first video game, wherein a respective feature indicates characteristics of a virtual object in a virtual environment of the first video game supported by a first game engine;
deriving, based on the set of identified features, a set of parameters indicating one or more physical characteristics of one or more virtual objects in the virtual environment; and
storing the set of derived parameters in a file format readable by a second game engine different from the first game engine, thereby allowing the second game engine to support a second video game that incorporates the one or more physical characteristics.
